(19) United States
(12) Patent Application Publication
(10) Pub. No.: US 2004/0252640 A1
(43) Pub. Date: Dec. 16, 2004

(54) Method for levying charges

(75) Inventor: Jurgen Focke, Berlin (DE)

Correspondence Address: MORRISON & FOERSTER LLP, 1650 TYSONS BOULEVARD, SUITE 300, MCLEAN, VA, 22102, US

(73) Assignee: SIEMENS AKTIENGESELLSCAFT, Munchen (DE)

(21) Appl. No.: 10/812,396

(22) Filed: Mar. 30, 2004

(30) Foreign Application Priority Data
Mar. 31, 2003 (DE) 10315803.0

(51) Int. Cl. H04L 12/26

(52) U.S. Cl. 370/229

(57) ABSTRACT

The invention relates to a method for levying charges for the provision of a chargeable service in a telecommunication network (TKN), in which a communication terminal (KEG) connected with a service user sends a first service request message (DAN1) to a service computer (DR) which provides the chargeable service, this first service request message is received and detained by an intermediate node (ZK) in the telecommunication network, the intermediate node prompts a second service request message (DAN2) to be created and transmitted to a routing service computer (D-DR) which has an associated individual identifier (IP2), the routing service computer requests the chargeable service from the service computer, the routing service computer then transfers a service message (DN) to the communication terminal, an exchange (V) which is arranged, in relation to the flow of messages, between the communication terminal and the routing service computer identifies from the identifier (IP2) that chargeable service use is involved, and a charge message (GN) is created.

This application claims priority to German application No. 10315803.0 filed Mar. 31, 2003, in the German language, the contents of which are hereby incorporated by reference.

The invention relates to a method for levying charges for the provision of a chargeable service in a telecommunication network.

Modern telecommunication networks are today used to provide a multiplicity of services for users of the telecommunication networks. Such services may be, besides the ordering of physical goods, the ordering and delivery of information or data (e.g. up-to-date stock market information, pictures, pieces of music or newspaper articles). There is an increasing tendency for such services no longer (as in the early days of the Internet, for example) to be provided at no cost, but rather for charges to be levied for such services. The prospect of income from charges also incites service providers to provide particularly high value services for the users of the telecommunication networks. Such telecommunication networks which are used are, by way of example, the Internet, telephone land line networks or second and third generation mobile radio networks.

The invention is based on the object of specifying a method which allows charges to be levied for individual services.

The invention achieves this object by means of a method for levying charges for the provision of a chargeable service in a telecommunication network, in which a communication terminal connected with a service user sends a first service request message to a service computer which provides the chargeable service and is connected to the telecommunication network, this first service request message is received and detained by an intermediate node in the telecommunication network which (intermediate node) is arranged, in relation to the flow of messages, between the communication terminal and the service computer, the intermediate node prompts a second service request message, relating to the chargeable service, to be created and transmitted to a routing service computer which has an associated individual identifier, the routing service computer requests the chargeable service from the service computer, the routing service computer then receives a service message from the service computer, the routing service computer transfers the service message together with the identifier for the routing service computer to the communication terminal, an exchange which is arranged, in relation to the flow of messages, between the communication terminal and the routing service computer identifies from the identifier that chargeable service use is involved, and the exchange then creates a charge message relating to the service use and to the service user. In this case, the exchange advantageously identifies from the identifier that chargeable service use is involved, and then creates the charge message. This advantageously makes it possible for the exchange to be able to identify chargeable service use with certainty and for a unit within the telecommunication network (namely the intermediate node in cooperation with the routing service computer) to be able to use the identifier to stipulate which services are chargeable; this stipulation is made independently of the service computer or of an operator of the service computer.

The inventive method can proceed such that the intermediate node prompts the second service request message, relating to the chargeable service, to be created and transmitted to the routing service computer by virtue of the intermediate node returning a readdressing message to the communication terminal, with the readdressing message containing an identifier for the routing service computer, and the communication terminal taking the readdressing message as a basis for creating the second service request message and sending it to the routing service computer. In the case of this embodiment of the inventive method, the readdressing message is advantageously used to prompt the communication terminal to create the second service request message and to send it to the routing service computer. This also advantageously takes into consideration a security aspect in telecommunication networks according to which it is desirable for changes to the destination of messages to be made by the sender of the messages.

The inventive method can be in a form such that receipt of the first service request message by the intermediate node is followed by the intermediate node using the first service request message to ascertain whether the requested service is chargeable, the first service request message being forwarded unchanged to the service computer in the case of a toll-free service, and creation and transmission of the second service request message being prompted only in the case of a chargeable service. This advantageously means that a second service request message needs to be created only in the case of chargeable services. In the case of a toll-free service, the first service request message is forwarded unchanged to the service computer; the routing service computer is not troubled in this case.

The inventive method can proceed such that the readdressing message returned is a redirect message designed as prescribed by the hypertext transfer protocol. Such a redirect message is advantageously interpreted correctly according to standard by a multiplicity of communication terminals. This makes it possible to use standard mobile telephones, for example, for the inventive method which require no modification for use in the inventive method.

The readdressing message can contain, as identifier, an IP address for the routing service computer.

The inventive method can proceed such that the intermediate node uses the first service request message to ascertain whether the requested service is chargeable by comparing a feature which describes the service in the service request message with a plurality of features which are stored at the intermediate node and are associated with chargeable services, and identifying the requested service as chargeable if there is a match. This is a particularly easily implemented method for ascertaining the chargeability of a service.

The method can also proceed such that the second service request message contains information about the service computer in the form of a URL address, this URL address is transmitted to a translation node, the translation node returns the IP address associated with the URL address, and the routing service computer uses the IP address of the service computer to request the chargeable service. This configuration of the inventive method advantageously allows the routing service computer to send the second service request message to the service computer even though the routing service computer does not know the IP address of the service computer on account of the readdressing of the service request message which has taken place previously.

The inventive method can be in a form such that the routing service computer requests the chargeable service by using the IP address to address the service computer, and using the URL address to select the chargeable service which is to be provided by the service computer.

The inventive method can proceed such that creation of the charge message involves the exchange using the identifier transferred with the service message to ascertain a charge tariff associated with the identifier, the level of the charge being determined using the charge tariff, and information about the level of the charge being added to the charge message. In this case, the identifier advantageously determines the respective charge tariff to be applied. Since the identifier is stipulated and selected independently of the service computer, it is possible to apply various charge tariffs independently of an operator of the service computer.

The method in line with the application can proceed such that the exchange determines the period of time required for transferring the service message, and the period of time and the ascertained charge tariff are used to determine the level of the charge. The method can also proceed such that the exchange determines the volume of data in the service message, and the volume of data and the ascertained charge tariff are used to determine the level of the charge. This advantageously allows the level of the charge to be determined both on the basis of the time needed for transferring the service message and on the basis of the volume of data in the service message using the respectively ascertained service-specific charge tariff.

The inventive method can also proceed such that transfer of the service message to the communication terminal KEG is followed by the intermediate node creating a second charge message, which contains information about a blanket charge associated with the service. This advantageously means that a blanket charge can also be levied independently of the time and/or volume dependent levying of charges when a chargeable service is being used.

The charge message and/or the second charge message can be transferred from the exchange to a payment system which handles the rest of the financial side of charge levying (for example debiting from an account or invoicing).

The translation node used may be a domain statement server (DNS).

To explain the invention further,

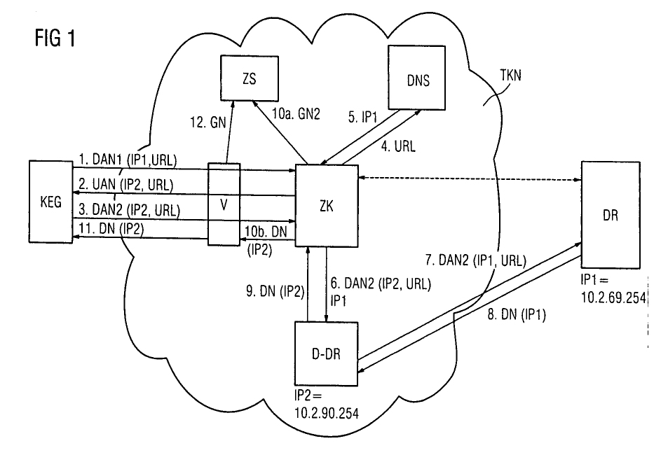

FIG. 1 shows an exemplary embodiment of method steps in the inventive method,

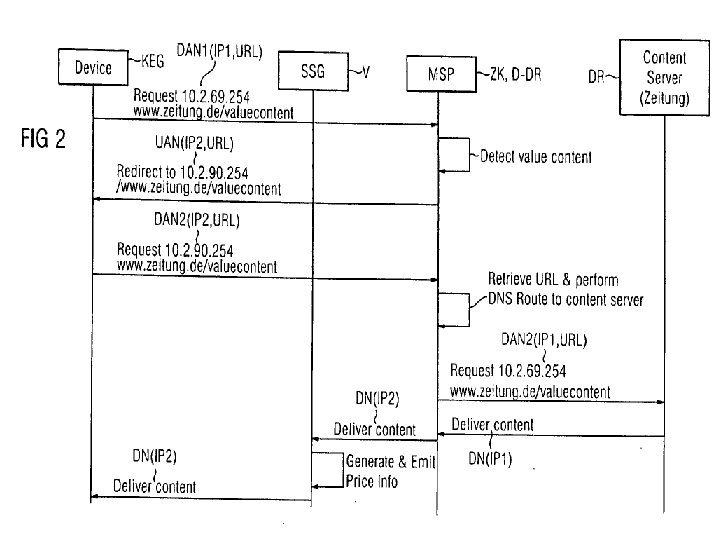

FIG. 2 shows a diagrammatic illustration of an exemplary embodiment of messages transferred in the course of the inventive method, and

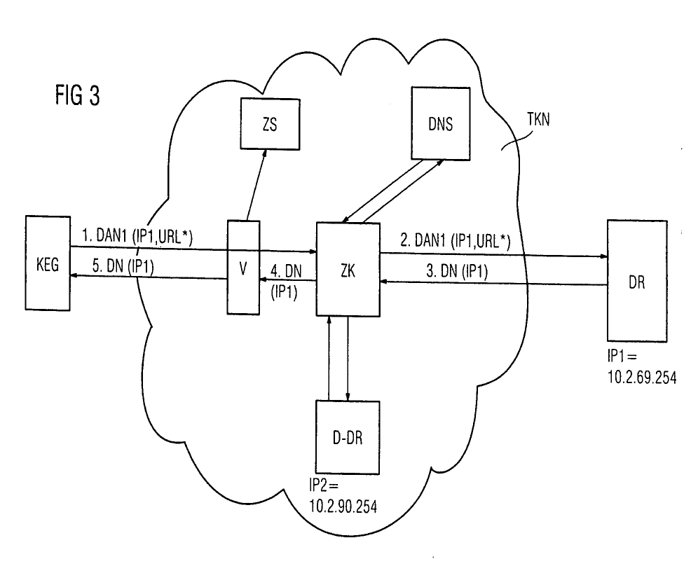

FIG. 3 shows a further exemplary embodiment of method steps in the inventive method.

FIG. 1 schematically shows a telecommunication network TKN, which is a mobile radio network connected to the Internet in the exemplary embodiment. The invention is not limited to mobile radio networks, however, but rather the inventive method can also be used in other types of telecommunication networks, e.g. in telephone landline networks or on the Internet. A user of the mobile radio network TKN has a communication terminal KEG, in the exemplary embodiment a communication terminal in the form of a mobile telephone KEG. This communication terminal KEG is intended to be used to use a service which is provided by a service computer DR connected to the telecommunication network TKN. The service computer DR is a “server computer” providing services for users of the telecommunication network. The service computer DR may specifically be an Internet server, for example, which is part of the known Internet and is connected to the telecommunication network TKN. In the exemplary embodiment, the service computer DR is a server connected with a newspaper publisher, said server storing various newspaper articles or other collected data in the form of Internet pages (“http pages”). Selected Internet pages on the service computer DR represent a “value-content”, i.e. Internet pages whose retrieval is chargeable. Other Internet pages stored on the service computer DR can be retrieved by communication terminals toll-free; such Internet pages are also called “non-value-content”. The service computer DR has an associated unique identifier in the form of an Internet address IP1=10.2.69.254. This identifier can be used for uniquely identifying and addressing the service computer DR.

The communication terminal KEG now requests a service on the service computer DR. This service involves the service computer DR needing to transfer a chargeable Internet page to the communication terminal KEG. The communication terminal KEG sends a first service request message DAN1 to the service computer DR. This first service request message DAN1 contains, as an address statement, the identifier IP1 for the service computer DR and a “URL address” (URL—Uniform Resource Locator) which selects the chargeable service which is to be provided by the service computer DR (in this case the Internet page to be transferred by the service computer DR). FIG. 1 therefore denotes the first service request message symbolically as “DAN1 (IP1, URL)”. Considered in detail, the first service request message DAN1 comprises a character string as shown in the diagrammatic illustration in FIG. 2: DAN1 (IP,URL)=request 10.2.69.254 www.zeitung.de/ valuecontent. In this case, the URL address is formed by the character string www.zeitung.de/valuecontent. This exemplary URL address signifies that the service computer connected with the newspaper publisher (which is addressed on the Internet using the domain statement “zeitung.de”) holds a stock of chargeable information pages (“valuecontent”) and transfers them as a service to communication terminals on request.

In line with FIG. 1, the first service request message DAN1 is sent via an exchange V to an intermediate node ZK in the telecommunication network, which is arranged, in relation to the flow of messages, between the communication terminal KEG and the service computer DR; this intermediate node ZK is a “proxy computer”. The intermediate node ZK receives the first service request message DAN1 and ascertains from the first service request message whether the requested service is chargeable or toll-free. In the exemplary embodiment, this is done by virtue of a feature which describes the service (in this case the URL address) in the service request message being compared with a plurality of URL addresses stored in the intermediate nodes for chargeable services. If the URL address in the first service request message matches a URL address which is stored in the intermediate node and is associated with a chargeable service, then the intermediate node ZK identifies that the requested service (i.e. the requested Internet page) is chargeable. If the relevant URL address in the first service request message DAN1 is not stored in the set of URL addresses at the intermediate node ZK, however, then the intermediate node ZK identifies that no charges are levied when the Internet page is requested, i.e. that the service is toll-free. This type of ascertainment of the chargeability of a service has the advantage that the comparison between the URL address and the stored URL addresses at the intermediate node can be performed very quickly and inconspicuously.

In the exemplary embodiment, it will be assumed that the intermediate node ZK has identified that the requested Internet pages are chargeable. The first service request message is then not forwarded from the intermediate node to the service computer DR (as illustrated by the dashed arrow in FIG. 1), but rather the intermediate node prompts a second service request message, relating to the chargeable Internet page, to be created and transmitted to a routing service computer D-DR which is connected to the intermediate node ZK. This routing service computer D-DR is a server in the telecommunication network TKN which has an associated identifier in the form of an IP address IP2=10.2.90.254. This IP address can be used to address the routing service computer D-DR (in a similar manner to the service computer DR). The routing service computer D-DR differs from the service computer DR in that the routing service computer D-DR cannot actually provide the Internet page delivery service itself, since no Internet pages are stored on the routing service computer D-DR. However, the routing service computer D-DR is able to retrieve the Internet pages from the “correct” service computer DR and to forward them to the communication terminal KEG. This is also illustrated by the label “routing service computer” in this application.

To prompt the second service request message, relating to the chargeable service, to be created and transmitted to the routing service computer D-DR, the intermediate node ZK returns a readdressing message UAN to the communication terminal KEG; this readdressing message contains, besides the IP address IP2 of the routing service computer D-DR, that URL address URL which has been transmitted to the intermediate node ZK with the first service request message DAN1. This readdressing message is labeled as UAN (IP2, URL) in FIG. 1 and comprises a character string as shown in FIG. 2: UAN(IP2,URL)=Redirect to 10.2.90.254/www.zeitung.de/ valuecontent.

The readdressing message used in this exemplary embodiment is a “redirect” message designed as prescribed by the hypertext transfer protocol. This redirect message prompts the communication terminal KEG to create a second service request message DAN2, which contains, as address statement, the identifier IP2 for the routing service computer and the known URL address URL. Apart from the address statement, the second service request message DAN2 can be identical to the first service request message DAN1. The communication terminal KEG sends this second service request message DAN2 to the routing service computer D-DR in the telecommunication network; the second service request message then arrives at the intermediate node ZK via the exchange V. The intermediate node ZK now extracts the URL address from the second service request message DAN2 and sends this URL address URL to a translation node DNS, which in the exemplary embodiment is formed by a domain statement server in the telecommunication network TKN. The domain statement server DNS returns the IP address IP1 associated with the URL to the intermediate node ZK. The intermediate node ZK then forwards the second service request message DAN2 together with the IP address IP1 (which is the identifier for the service computer DR) to the routing service computer D-DR. However, the routing service computer D-DR cannot—as already explained above—provide the requested service selected by the URL, since no Internet pages are stored on the routing service computer D-DR. The routing service computer D-DR provides the second service request message DAN2 with the identifier IP1 for the service computer DR and sends the second service request message DAN2 (IP1, URL) to the service computer DR.

The service computer DR then returns the Internet page selected by the URL address URL to the routing service computer D-DR in the form of a service message DN. This service message DN contains, as sender statement, the identifier IP1 (in this case the IP address 10.2.69.254) for the service computer DR. The routing service computer D-DR receives the service message DN containing the chargeable Internet page and forwards it to the communication terminal KEG, the routing service computer D-DR adding its identifier IP2=10.2.69.254 to the service message DN as a sender statement. From the point of view of the other elements in the telecommunication network, the routing service computer D-DR is thus the sender of the service message DN. The service message DN (IP2) is then transferred to the exchange V via the intermediate node ZK. The exchange V is situated, in relation to the flow of messages, between the routing service computer D-DR and the communication terminal KEG. The exchange V forwards the service message DN (IP2) to the communication terminal KEG and uses the identifier IP2 transferred as sender statement with the service message DN to ascertain a charge tariff associated with this identifier IP2. Charge tariff tables are stored in a memory in the exchange V, such a table being associated with the identifier IP2. The exchange V also determines the period of time needed for transferring the service message DN and the volume of data (in bytes) in the service message. The period of time, the volume of data and the ascertained charge tariff are used by the exchange to determine the level of the charge which needs to be paid for the Internet page. Information about the level of this charge is added to a charge message GN freshly created by the exchange. This charge message GN is then transferred from the exchange V to a payment system ZS. By way of example, the charge message can contain the information that the communication terminal KEG has received Internet pages with a volume of data of 100 kbytes from the routing service computer D-DR with the IP address IP2 and that the charge to be paid for this is 2 [symbol] . In other exemplary embodiments, the level of the charge can also be ascertained on the basis of just the identifier IP2, and the identifier IP2 and the period of time, or the identifier IP2 and the volume of data.

As a further option, the intermediate node ZK can create a second charge message GN2 and transfer it to the payment system ZS when the service message DN (IP2) is transferred to the communication terminal. The second charge message GN2 contains information about a blanket charge (for example amounting to 0.50 [symbol] ) which is levied for the service associated with the service message DN (IP2). Depending on the configuration of the charge tariff which is associated with the corresponding service and is stored in the exchange V, the occurrence of a blanket charge may involve a, for example reduced, time or volume dependent charge tariff being levied or even time or volume dependent charging being dispensed with. Alternatively, it is possible for the blanket charge to be levied in addition to the time and/or volume dependent charges.

The payment system ZS then handles the rest of the financial side for the charge levied. By way of example, the charge may be debited from a prepaid account in line with the level of the charge, or a corresponding charge entry may be stored for an invoice which is to be created at a later time. Such payment systems ZS are known per se. Examples of these are the payment system “payment@vantage” from Siemens AG (as advertised, by way of example, in the printed document “Real-time-Payment—Market, Trends, Product—Edition 10.2001” on pages 74 to 80) or the charge billing systems often provided in mobile radio networks, which work on the basis of call data records.

FIG. 2 gives another summarized description of the method described in connection with FIG. 1 using a diagrammatic message flowchart. The communication appliance KEG indicated in this context is an appliance, such as a mobile telephone or computer terminal, which is labeled generally “device”. The exchange V used is a “service selection gateway” SSG. Such exchanges are known and are described, by way of example, in the printed document “Cisco 6400 Feature Guide”, OL-0875-01, dated May 2001, particularly on pages 4-1 to 4-7. The intermediate node ZK and the routing service computer D-DR connected to the intermediate node are provided by a proxy unit MSP (mobile smart proxy). The service computer DR connected with the newspaper publisher is labeled “Content Server” in FIG. 2. The sequences illustrated in FIG. 2 correspond to the method steps illustrated in FIG. 1. Ascertainment of whether a chargeable service has been requested is labeled “Detect value content” (ascertained chargeable content). The reading of the URL address from the second service request message DAN2 by the intermediate node and the ascertainment of the associated IP address by means of the DNS server is labeled “Retrieve URL & perform DNS”. The transfer of the service message DN to the communication terminal KEG is shown by arrows “Deliver content”. The creation and transfer of the charge message GN to the payment system is labeled “Generate & Emit Price Info”.

FIG. 3 shows how the inventive method is simplified when a toll-free service is requested, i.e. a free Internet page is requested from the service computer DR using a service request message DAN (IP1, URL*). In this case, the URL address URL* points to a toll-free Internet page: URL*=http://www.zeitung.de/nonvaluepage.

The intermediate node ZK forwards this first service request message DAN1 unchanged to the service computer DR. This service computer DR returns the toll-free Internet page using a service message DN (IP1), which contains the identifier IP1 for the service computer DR as sender address, on a direct path to the intermediate node. The intermediate node ZK forwards the service message DN to the exchange. The exchange V identifies from the identifier IP1 that this service is not chargeable, that is to say is toll-free, and then forwards the service message DN transparently to the communication terminal KEG without determining the time needed for transfer or the data capacity of the service message DN and without generating and forwarding a charge message.

A particular advantage of the inventive method described is that charges can be levied correctly even when the service computer DR provides both chargeable and toll-free services (illustrated in the exemplary embodiment by the provision of Internet pages which can be requested toll-free and Internet pages which can be requested for a charge which are stored on one and the same server). The toll-free Internet pages are transferred using a service message DN (IP1) (cf. FIG. 3) which is transferred to the communication terminal KEG together with the identifier IP1 for the service computer. However, the chargeable Internet pages are transferred from the routing service computer D-DR to the communication terminal KEG using the service message DN (IP2) (cf. the method explained in connection with FIG. 1). This service message DN (IP2) is transferred to the communication terminal KEG together with the identifier IP2 for the routing service computer DR. Using the various identifiers (identifier IP1 for toll-free services, identifier IP2 for chargeable services), the exchange can correctly distinguish between service messages associated with chargeable services and service messages associated with toll-free services. The use of exchanges V which use identifiers (e.g. in the form of IP addresses) transferred with the service message to ascertain whether the corresponding service is chargeable and which use these identifiers to establish the associated charge tariff is advantageously possible even when a single service computer (service server) provided with a single IP address provides both chargeable and toll-free services.

Exchanges which can distinguish various service computers (server systems) only from their IP addresses can advantageously be used, in line with the invention, for correctly levying the charges even when a server system—as illustrated above—is used to offer and provide chargeable and toll-free services, that is to say when services subject to different charging methods are provided on a common server at one and the same IP address (charging=levying charges). The inventive method advantageously means that the service messages DN (IP2) relating to the chargeable services are transferred to the communication terminal KEG not by the service computer DR but rather by the routing service computer D-DR. For this reason, these service messages are transferred to the communication terminal KEG together with the identifier IP2 for the routing service computer. The exchange V therefore ascertains the identifier IP2 when analyzing these service messages and is able to distinguish these service messages from other service messages, associated with free services.

Advantageously—as already illustrated above—the use of the routing service computer D-DR means that transfer of the service messages DN from the service computer DR to the communication terminal KEG involves said service messages being modified such that the exchange V establishes, when analyzing these service messages, that the service messages come from the routing service computer D-DR. Using the identifier IP2 for the routing service computer D-DR, the exchange V can then distinguish the chargeable service messages from the toll-free messages.

The inventive method advantageously makes it possible for different chargeable services to be assigned different charge tariffs. This involves providing a routing service computer having a dedicated identifier IPx (x=2,3,4 . . . ) for each different charge tariff. If a common, standard charge tariff is applied for the chargeable services, however, then it is sufficient to use just one routing service computer having a single identifier.

1. A method for levying charges for the provision of a chargeable service in a telecommunication network (TKN), in which
a communication terminal (KEG) connected with a service user sends a first service request message (DAN1) to a service computer (DR) which provides the chargeable service and is connected to the telecommunication network (TKN),
the first service request message (DAN1) is received and detained by an intermediate node (ZK) in the telecommunication network (TKN) which (intermediate node) is arranged, in relation to the flow of messages, between the communication terminal (KEG) and the service computer (DR),
the intermediate node (ZK) prompts a second service request message (DAN2), relating to the chargeable service, to be created and transmitted to a routing service computer (D-DR) which has an associated individual identifier (IP2),
the routing service computer (D-DR) requests (DAN2) the chargeable service from the service computer (DR),
the routing service computer (D-DR) then receives a service message (DN) from the service computer,
the routing service computer (D-DR) transfers the service message (DN) together with the identifier (IP2) for the routing service computer to the communication terminal (KEG),
an exchange (V) which is arranged, in relation to the flow of messages, between the communication terminal (KEG) and the routing service computer (D-DR) identifies from the identifier (IP2) that chargeable service use is involved, and
the exchange (V) then creates a charge message (GN) relating to the service use and to the service user (KEG).

2. The method as claimed in claim 1,
characterized in that
the intermediate node (ZK) prompts the second service request message (DAN2), relating to the chargeable service, to be created and transmitted to the routing service computer (D-DR) by virtue of
the intermediate node (ZK) returning a readdressing message (UAN) to the communication terminal (KEG), with the readdressing message (UAN) containing the identifier (IP2) for the routing service computer (D-DR), and
the communication terminal (KEG) taking the readdressing message (UAN) as a basis for creating the second service request message (DAN2) and sending it to the routing service computer (D-DR).

3. The method as claimed in claim 1,
characterized in that
receipt of the first service request message (DAN1) by the intermediate node (ZK) is followed by
the intermediate node using the first service request message (DAN1) to ascertain whether the requested service is chargeable,
the first service request message (DAN1) being forwarded unchanged to the service computer (DR) in the case of a toll-free service, and
creation and transmission of the second service request message (DAN2) being prompted only in the case of a chargeable service.

4. The method as claimed in claim 2,
characterized in that
the readdressing message returned is a redirect message (UAN) designed as prescribed by the hypertext transfer protocol.

5. The method as claimed in claim 2,
characterized in that
the readdressing message (UAN) contains, as identifier, an IP address (IP2) for the routing service computer (D-DR).

6. The method as claimed in claim 3,
characterized in that
the intermediate node (ZK) uses the first service request message (DAN1) to ascertain whether the requested service is chargeable by
comparing a feature (URL) which describes the service in the service request message (DAN1) with a plurality of features which are stored at the intermediate node and are associated with chargeable services, and
identifying the requested service as chargeable if there is a match.

7. The method as claimed in claim 1,
characterized in that
the second service request message (DAN2) contains information about the service computer (DR) in the form of a URL address (URL),
this URL address (URL) is transmitted to a translation node (DNS),
the translation node (DNS) returns the IP address (IP1) associated with the URL address, and
the routing service computer (D-DR) uses the IP address (IP1) of the service computer (DR) to request (DAN2) the chargeable service.

8. The method as claimed in claim 7,
characterized in that
the routing service computer (D-DR) requests (DAN2(IP1,URL)) the chargeable service by
using the IP address (IP1) to address the service computer (DR), and
using the URL address (URL) to select the chargeable service which is to be provided by the service computer.

9. The method as claimed in claim 1,
characterized in that
creation of the charge message (GN) involves
the exchange (V) using the identifier (IP2) transferred with the service message (DN) to ascertain a charge tariff associated with the identifier,
the level of the charge being determined using the charge tariff, and
information about the level of the charge being added to the charge message (GN).

10. The method as claimed in claim 9,
characterized in that
the exchange (V) determines the period of time required for transferring the service message (DN), and
the period of time and the ascertained charge tariff are used to determine the level of the charge.

11. The method as claimed in claim 9,
characterized in that
the exchange determines the volume of data in the service message (DN), and
the volume of data and the ascertained charge tariff are used to determine the level of the charge.

12. The method as claimed in claim 1,
characterized in that
transfer of the service message (DN) to the communication terminal (KEG) is followed by the intermediate node (ZK) creating a second charge message (GN2), which contains information about a blanket charge associated with the service.

13. The method as claimed in claim 12,
characterized in that
the charge message (GN) and/or the second charge message (GN2) is/are transferred from the exchange (V) to a payment system (ZS).

14. The method as claimed in claim 7,
characterized in that
the translation node used is a domain statement server (DNS).
